(19) United States
(12) Patent Application Publication
(10) Pub. No.: US 2011/0112270 A1
(43) Pub. Date: May 12, 2011

(54) Low Melting Polyurethane Elastomers

(75) Inventor: Donald A. Meltzer, Akron, OH (US)

(73) Assignee: LUBRIZOL ADVANCED MATERIALS, INC., Cleveland, OH (US)

(21) Appl. No.: 12/747,967

(22) PCT Filed: Dec. 12, 2008
(86) PCT No.: PCT/US03/86557

§ 371 Date: Jun. 14, 2010

Related U.S. Application Data
(60) Provisional application No. 61/013,737, filed on Dec. 14, 2007.

(51) Int. Cl. C08G 18/32

(52) U.S. Cl. 528/83; 528/85

(57) ABSTRACT

The present invention relates generally to polyurethane elastomer compositions; and more preferably to thermo-plastic polyurethane elastomer compositions. In one embodiment, the polyurethane elastomer compositions of the present invention have low melting points while still behaving in an elastomeric manner. In one embodiment, the polyurethane elastomer compositions of the present invention are prepared from the reaction of a polyol component, a polyisocyanate component, and a diol chain extender. In another embodiment, the polyurethane elastomer compositions of the present invention are prepared from the reaction of a polyester polyol component, a methylene diphenyl diisocyanate (MDI) component, and a linear diol chain extender having either 5 carbons or 7 or more carbons between the OH groups of the diol.

### FIELD OF THE INVENTION

The present invention relates generally to polyurethane elastomer compositions; and more preferably to thermoplastic polyurethane elastomer compositions. In one embodiment, the polyurethane elastomer compositions of the present invention have low melting points while still behaving in an elastomeric manner. In one embodiment, the polyurethane elastomer compositions of the present invention are prepared from the reaction of a polyol component, a polyisocyanate component, and, a diol chain extender. In another embodiment, the polyurethane elastomer compositions of the present invention are prepared from the reaction of a polyester polyol component, a methylene diphenyl diisocyanate (MDI) component, and a linear diol chain extender haying either 5 carbons or 7 or more carbons between the OH groups of the diol.

### BACKGROUND OF THE INVENTION

Thermoplastic polyurethanes elastomers are usually produced by reacting a polyol compound with a diisocyanate and a chain extender and have linear polymeric molecular structures having hard segment portions and soft segment portions. Thermoplastic polyurethanes elastomers formed in accordance with this general recipe generally fall into one of two main classes: (1) TPUs that exhibit good elastomeric properties and a melting point of greater than 135° C. (determined by differential scanning calorimetry (DSC) at a 10° C./minute heating rate); or (2) TPU's that behave more like a plastic than an elastomer and have a melting point of less than 135° C.

U.S. Pat. No. 5,990,258 relates to cast thermoplastic polyurethanes elastomers (TPUs) with high resilience and high clarity for use in roller skate wheels. As disclosed therein, the TPUs of U.S. Pat. No. 5,9.90,258 are formed from a combination of a polyether or polycaprolactones polyol, a methylene diphenyl diisocyanate (MDI), and at least one diol chain extender having the formula OH—(CH₂)ₓ—OH where x is an integer from 5 to about 16. Additionally, the MDI component of this patent is disclosed to contain about 4,4′-MDI, to about 0 to about 60 weight percent 2,4′-MDI, and less than about 6 weight percent 2,2′-MDI.

U.S. Pat. No. 6, 221,999 relates to cast thermoplastic polyurethanes elastomers (TPUs) with high resilience and high clarity. As disclosed therein, the TPUs of U.S. Pat. No. 6,221,999 are formed from a combination of a polyether polyol, a methylene diphenyl diisocyanate (MDI), and at least one diol chain extender having the formula OH—(CH₂)ₓ—OH where x is an integer from 5 to about 16. Additionally, the MDI component of this patent is disclosed to contain at least 70 weight percent 4,4′-MDI. This is because, as is disclosed in U.S. Pat. No. 6,221,999, an increase in the content of either the 2,4′-MDI or 2,2′-MDI isomers leads to an undesirable decrease in the resiliency of the TPU elastomer so produced.

### SUMMARY OF THE INVENTION

The present invention relates generally to polyurethane elastomer compositions; and more preferably to thermoplastic polyurethane elastomer compositions. In one embodiment, the polyurethane elastomer compositions of the present invention have low melting points while still behaving in an elastomeric manner. In one embodiment, the polyurethane elastomer compositions of the present invention are prepared from the reaction of a polyol component, a polyisocyanate component, and a diol chain extender. In another embodiment, the polyurethane elastomer compositions of the present invention are prepared from the reaction of a polyester polyol component, a methylene diphenyl diisocyanate (MDI) component, and a linear diol chain extender having either 5 carbons or 7 or more carbons between the OH groups of the diol.

In one embodiment, the present invention relates to a thermoplastic polyurethane elastomer composition comprising: the reaction product of: (a) at least one polyester polyol selected from one or more polyadipates, one or more polyazelates, one or more polybutyrates, one or more polycarbonates, or a suitable combinations of two or more thereof; (b) at least one polyisocyanate; and (c) at least one diol chain extender, where the at least one chain extender comprises one or more compounds according to the following formula:

OH—(CH₂)ₓ—OH

where x is either equal to 5 or is an integer in the range of 7 to about 30, and wherein the at least one polyisocyanate comprises at least about 95 weight percent of diphenylmethane-4,4′-diisocyanate.

In another embodiment, the present invention relates to a thermoplastic polyurethane elastomer composition comprising: the reaction product of: (a) at least one polyester polyol selected from one or more polyadipates, one or more polyazelates, one or more polybutyrates, one or more polycarbonates, or a suitable combinations of two or more thereof; (b) at least one polyisocyanate; and (c) at least one dial chain extender, where the at least one chain extender, comprises one or more compounds according to the following formula:

OH—(CH₂)ₓ—OH

where x is an integer in the range of 8 to about 25, wherein the at least one polyisocyanate comprises at least about 95 weight percent of diphenylmethane-4,4′-diisocyanate, and wherein the overall number average molecular weight of the at least one polyester polyol is in the range of from about 2,000 to about 15,000.

In still another embodiment, the present invention relates to an extruded thermoplastic polyurethane elastomeric film formed from a thermoplastic polyurethane elastomer composition comprising: the reaction product of: (a) at least one polyester polyol; (b) at least one polyisocyanate; and (c) at least one diol chain extender, where the at least one chain extender comprises one or more compounds according to the following formula:

OH—(CH₂)ₓ—OH

where x is either equal to 5 or is an integer in the range of 7 to about 30, and wherein the at least one polyisocyanate comprises at least about 95 weight percent of diphenylmethane-4,4′-diisocyanate.

In still another embodiment, the present invention relates to an extruded thermoplastic polyurethane elastomeric film formed from a thermoplastic polyurethane elastomer composition comprising: the reaction product of: (a) at least one polyester polyol; (b) at least one polyisocyanate; and (c) at least one diol chain extender, where the at least one chain extender comprises one or more compounds according to the following formula:

OH—(CH₂)ₓ—OH

where x is an integer in the range of 8. about 25, wherein the at least one polyisocyanate comprises at least about 95 weight percent of diphenylmethane-4,4′-diisocyanate, and wherein the overall number average molecular weight of the at least one polyester polyol is in the range of from about 2,000 to about 15,000.

### DETAILED DESCRIPTION OF THE INVENTION

The present invention relates generally to polyurethane elastomer compositions; and more preferably to thermoplastic polyurethane elastomer compositions. In one embodiment, the polyurethane elastomer compositions of the present invention have low melting points while still behaving in an elastomeric manner. In one embodiment, the polyurethane elastomer compositions of the present invention are prepared from the reaction of a polyol component, a polyisocyanate component, and diol chain extender. In another embodiment, the polyurethane elastomer compositions of the present invention are prepared from the reaction of a polyester polyol component, a methylene diphenyl diisocyanate (MDI) component, and a linear diol chain extender having either 5 carbons or 7 or more carbons between the OH groups of the diol.

In one embodiment, the thermoplastic polyurethane elastomer compositions of the present invention can be utilized to prepare films and/or other materials. Such TPU films and/or other materials can be formed by a variety of techniques including, but not limited to, extrusion froth pellets. It should be noted that the present invention is not limited to just films formed from TPU elastomer compositions disclosed herein.

In another embodiment, the thermoplastic polyurethane elastomer compositions of the present invention can be utilized to prepare films that are suitable for use in the garment industry for use in, for example, stitchless or seamless garments.

In one embodiment, the polyurethane elastomer compositions described herein can be prepared by numerous methods known in the art. In one embodiment a one-shot polymerization process is utilized where all of the reactants are combined simultaneously or substantially simultaneously and reacted. In one instance, such a one-shot process can be performed in an extruder. In another embodiment, the TPUs of the present invention can be polymerized in a variety of step-wise addition processes (e.g., a random melt polymerization process as is known in the art).

The term “polyurethane elastomer composition” when utilized throughout the specification can refer to a composition containing the necessary reagents utilized to form a polyurethane elastomer, or a composition subsequent to reaction of polyurethane elastomer forming reagents by some process or mechanism. As is noted above, the thermoplastic polyurethane elastomer polymers of the present invention comprise the reaction product of a polyester polyol component, a methylene diphenyl diisocyanate (MDI) component, and a linear diol chain extender having either 5 carbons or 7 or more carbons between the OH groups of the diol.

In one embodiment, the polyurethane elastomer compositions in accordance with the present invention have a Kolfer melting temperature of a resin of less than about 120° C. In another embodiment, the polyurethane elastomer compositions in accordance with the present invention have a 200% tensile set at room temperature (i.e., 20° C. to 23.5° C.) of less than about 20% when tested in accordance with ASTM D412, or even less than about 15%. In still another embodiment, the polyurethane elastomer compositions in accordance with the present invention have a tensile set after 3 cycles to 100% elongation is less than about 10%, or even less than about 5%.

As is known to those of skill in the art, the method by which a thermoplastic polyurethane elastomer composition is produced impacts the physical and chemical properties of such a thermoplastic polyurethane elastomer composition. Additionally, the method by which a thermoplastic polyurethane elastomer product is formed impacts the physical and chemical properties of such a thermoplastic polyurethane elastomer product. Given this, identical polyurethane elastomer compositions that are produced via two different methods (e.g., solution versus bulk polymerization) into similar products would possess different physical and chemical properties.

### Polyols:

As noted above, the thermoplastic polyurethane elastomers of the present invention are the reaction product of a polyester polyol component. By “polyester polyol component” it is meant that the polyester polyol component is formed from the combination of one or more polyester polyols having a number average molecular weight (Mₙ) of at least about 1,000, at least about 1,500, or even at least about 2,000. Here, as well as elsewhere in the specification and claims, individual range limits can be combined to form non-disclosed ranges. In one embodiment, suitable polyester polyols include, but are not limited to, polyadipates, polyazelates, polybutyrates, polycarbonates, and suitable combinations of two or more thereof.

In another embodiment, the overall number average molecular weight of the one or more polyester polyols utilized in connection with the present invention is in the range of from about 1,000 to about 15,000, or from about 1,500 to about 12,000, or from about 2,000 to about 10,000, or even from about 2,000 to about 5,000.

By “overall number average molecular weight” it is meant that the numerical average of the polyester polyol component of the present invention is calculated based on the different molecular weights and proportions of the one or more polyester polyols contained therein. As such, polyester polyols having number average molecular weight outside the above ranges, could be utilized in the present invention so long as the overall number average molecular weight of a mixed polyester polyol component falls within one or more of the above ranges.

In another embodiment, blends of one or more polyester polyols can be utilized in the present invention. In another embodiment, the polyester polyol portion of the present invention is selected from a suitable single polyester polyol.

Suitable polyester polyols for use in the present invention are, commercially available from Inolex such as Lexorez® 1600-55, 1640-55 or 1100-35; or from Polyurethane Specialties such as Millester® 11-55, 23 or 9-55.

### Polyisocyanates:

The polyurethane elastomer polymers of the present invention are formed from a polyurethane elastomer composition containing an isocyanate component. In order to form relatively long linear polyurethane elastomer chains, di-functional Or even polyfunctional isocyanates are utilized. In one embodiment, one or more diisocyanates are utilized. Suitable polyisocyanates are commercially available from companies such as, but not limited to, Bayer Corporation of Pittsburgh, Pa., The BASF Corporation of Parsippany, N.J., The Dow Chemical Company of Midland, Mich., and Huntsman Chemical of Utah. The polyisocyanates of the present invention generally have a formula R(NCO)ₙ where n is 2. R can be an aromatic, a cycloaliphatic, an aliphatic, or combinations thereof having from 2 to about 20 carbon atoms. Examples of polyisocyanates include, but are not limited to, diphenylmethane-4,4′-diisocyanate (MDI), toluene-2,4-diisocyanate (TDI), toluene-2,6-diisocyanate (TDI), methylene bis(4-cyclohexylisocyanate (H₁₂MDI), 3-isocyanatomethyl-3,5, 5-trimethyl-cyclohexyl isocyanate (IPDI), 1,6-hexane diisocyanate (HDI), naphthalene-1,5-diisocyanate (NDI), 1,3- and 1,4 -phenylenediisocyanate, triplienylmethane-4,4′,4″-triisocyanate, polyphenylpolymethylenepolyisocyanate (PMDI), m-xylene diisocyanate (XDI), 1,4-cyclohexyl diisocyanate (CHDI), isophorone diisocyanate, isomers, dimers, trimers and mixtures or combinations of two or more thereof.

In another embodiment, the polyurethane elastomer polymers of the present invention are formed from a polyurethane elastomer composition containing a diphenylmethane diisocyanate (MDI) component. As is known to those of skill in the art, MDI is an isomeric mixture composed of 4,4′-MDI and other isomers such as, for example, the 2,4′-MDI and 2,2′-MDI isomers. Given this, in one embodiment, the polyisocyanate used in conjunction with the present invention comprises MDI where such MDI comprises primarily the 4,4′-MDI isomer. By primarily, it is meant that at least about 95 weight percent of such an MDI component is formed by 4,4′-MDI, or at least about 97 weight percent 4,4′-MDI, or even at least about 98 weight percent 4,4′-MDI, or even at least about 99 weight percent 4,4′-MDI.

### Chain Extenders:

Chain extenders are employed in the production of the polyurethane elastomer compositions of the present invention. In one embodiment, the chain extenders utilized in connection with the present invention are selected from those chain extenders having a long linear hydrocarbon chain terminated by two OH groups. In another embodiment, the chain extenders utilized in connection with the present invention are selected from those diol chain extenders having the following general formula:

OH—(CH₂)ₓ—OH

where x is equal to 5 or is an integer of at least 7. In another embodiment, x is equal to .5 or is an integer in the range of 7 to about 30; or x is in the range of about 8 to about 25, or x is in the range of about 9 to about 20, or x is in the range of about 12 to about 15, or x is even in the range of about 9 to about 12. In one embodiment, x is equal to 5, 9 or 12.

In another embodiment, the chain extender of the present invention is 1,12-dodecanediol (C₁₂-diol). In still another embodiment, two or more of the above chain extenders can be combined to form a mixed chain extender component for use in conjunction with the present invention. In still another embodiment, a second chain extender other than those chain extenders discussed above can be mixed with one or more of the above chain extenders to form a mixed chain extender component for use in conjunction with the present invention.

The molar amount or ratio of the total hydroxyl groups of the one or more chain extenders utilized to the total hydroxyl groups of the polyester polyol component set forth above is generally from about 0.1 to about 5.0, or from about 0.2 to about 4.0, or even from about 0.4 to about 2.5.

### Polymerization Process and Additional Additives:

As is noted above, the thermoplastic polyurethane (TPUs) elastomers of the present invention are formed from the reaction of (1) a polyester polyol component; (2) one or more polyisocyanates; and (3) one or more chain extenders. Numerous methods of forming polyurethane are known including the multi-step process of reacting the polyester polyol component with the polyisocyanate component and then chain extending the same.

The thermoplastic polyurethane elastomers of the present invention are, in one embodiment, produced by the “one-shot” polymerization process as known in the art, wherein the polyester polyol component, polyisocyanate component, and the chain extender are added together, mixed, and polymerized. Desirably, the polyester polyol component and the chain extender are added in one stream and the polyisocyanate is added in a second stream. In one instance, the one-shot polymerization, process is performed in an extruder. The monomers are supplied for the polymerization reaction and the reaction is performed at a temperature in the range of about 60° C. to about 220° C., or from about 100° C. to about 210° C., or even from about 120° C. to about 200° C. Suitable mixing times to enable the various components to react and form the thermoplastic polyurethanes of the present invention are, in one embodiment, from about 1 minute to about 10 minutes, or from about 2 minutes to, about 7 minutes, or even from about 3 minutes to about 5 minutes.

The molar ratio of polyisocyanate functional groups to total hydroxyl groups of the mixed polyol component and chain extender is, in one embodiment, from about 0.90 to about 1.10, or even from about 0.95 to about 1.05.

The weight average molecular weight of the polymerized thermoplastic polyurethane elastomers of the present invention generally range from about 10,000 to about 500,000, or from about 25,000 to about 400,000, or even from about 50,000 to about 300,000.

In addition to the above-identified components, the TPU elastomer compositions of the present invention can also optionally contain various additives, pigments, dyes, fillets, lubricants, UV absorbers, waxes, antioxidants, thickening agents and the like, which can be utilized in conventional amounts as known to those of skill in art or in the literature. The additives utilized generally impart desired properties to the thermoplastic polyurethane elastomers. Fillers include talc, silicates, clays, calcium carbonate, and the like.

If it is desired that the polyurethane elastomer compositions of the present invention have a color or hue, any conventional pigment or dye can be utilized in conventional amounts. Hence, any pigment known to those of skill in the art, or in the literature, can be utilized as for example titanium dioxide, iron oxide, carbon black, and the like, as well as various dyes, provided that they do not interfere with the various urethane reactions.

The thermoplastic polyurethane (TPU) elastomers of the present invention can be extruded into any desired end product or form, or can be cooled and pelletized or granulated for storage or bulk shipping. The extrudate can be immediately processed in some other manner after extrusion to give a desired final end use product.

The present invention will be better understood with reference to the following examples which serve to illustrate the present invention. It should be noted that the present invention is not limited solely to the examples set forth below.

### EXAMPLES

Tables 1 and 2 illustrate various polyurethane elastomer formulations that are Comparative Examples 1-6. Tables 3-8 show Examples 1-18 according to the present invention.

The thermoplastic polyurethane elastomer polymers illustrated below are prepared by a random melt polymerization method. In this method, the polyester polyol component and the chain extender (e.g., 1,12-dodecanediol (C₁₂-diol)) are mixed together at a temperature of about 120° C. and supplied to a reactor fitted with a mechanical stirrer. Also, supplied to the reactor for addition to the polyester polyol component/chain extender combination is a pre-heated polyisocyanate (e.g., a suitable MDI component at 120° C.). The resulting TPUs are tested for T_{g} (glass transition temperature), and Tₘ (melting temperature), and T_{c} (crystallization temperature) by DSC. The materials are then compression molded into a 5 mil film for Kofter Tₘ testing and a 30 mil film for tensile set testing. The results of these various tests are reported in Tables 1 through 8.

TABLE 1

| | Example | | |
|---|---|---|---|
| | Comparative | Comparative | Comparative |
| | 1 | 2 | 3 |
| Polyester Polyol (g)¹ | 188.80 | 188.80 | 1888.80 |
| 1,4-Butanediol (1,4-BDO) (g) | 11.20 | 11.20 | 11.20 |
| MDI (g) | 49.07 | 49.45 | 49.82 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2500 | 2500 | 2500 |
| 1,4-BDO M_{w} | 90 | 90 | 90 |
| MDI M_{w} | 250.4 | 250.4 | 250.4 |
| CE/Polyol Mole Ratio | 1.648 | 1.648 | 1.648 |
| Stoichiometry (%) | 98.00 | 98.00 | 98.00 |
| Tₘ by DSC (° C.) | 145 | 145 | 133 |
| T_{g} by DSC (° C.) | −44 | −37 | −37 |
| T_{c} by DSC (° C.) | 48 | 40 | 38 |
| M_{w} by GPC | 145153 | 366119 | 263097 |
| Mₙ by GPC | 63396 | 98278 | 76133 |
| Kofler Tₘ (° C.) | 131 | 134 | 126 |
| 200% Tensile Set (%) | 6 | 5 | 4 |

¹1,6-Hexandiol-1,4-Butanediol Adipate

TABLE 2

| | Example | | |
|---|---|---|---|
| | Comparative | Comparative | Comparative |
| | 4 | 5 | 6 |
| Polyester Polyol (g)² | 190.00 | 190.00 | 190.00 |
| 1,4-Butanediol (1,4-BDO) (g) | 10.00 | 10.00 | 10.00 |
| MDI (g) | 49.55 | 50.32 | 51.09 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2000 | 2000 | 2000 |
| 1,4-BDO M_{w} | 90 | 90 | 90 |
| MDI M_{w} | 250.4 | 250.4 | 250.4 |
| CE/Polyol Mole Ratio | 1.170 | 1.170 | 1.170 |
| Stoichiometry (%) | 96.00 | 97.50 | 99.00 |
| Tₘ by DSC (° C.) | 129 | 131 | 131 |
| T_{g} by DSC (° C.) | −30 | −26 | −26 |
| T_{c} by DSC (° C.) | None | None | None |
| M_{w} by GPC | 63616 | 76991 | 104235 |
| Mₙ by GPC | 32356 | 35941 | 42811 |
| Kofler Tₘ (° C.) | 99 | 100 | 103 |
| 200% Tensile Set (%) | 9 | 8 | 8 |

²Ethylene Glycol-1,4-Butanediol Adipate

TABLE 3

| | Example | | |
|---|---|---|---|
| | 1 | 2 | 3 |
| Polyester Polyol (g)¹ | 176.50 | 176.50 | 176.50 |
| 1,12-Dodecanediol (1,12-Diol) (g) | 23.50 | 23.50 | 23.50 |
| MDI (g) | 45.88 | 46.23 | 46.58 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2500 | 2500 | 2500 |
| 1,12-Diol M_{w} | 202 | 202 | 202 |
| MDI M_{w} | 250.4 | 250.4 | 250.4 |
| CE/Polyol Mole Ratio | 1.648 | 1.648 | 1.648 |
| Stoichiometry (%) | 98.00 | 98.75 | 99.50 |
| Tₘ by DSC (° C.) | 124 | 123 | 122 |
| T_{g} by DSC (° C.) | −45 | −42 | −44 |
| T_{c} by DSC (° C.) | 32 | 28 | 27 |
| M_{w} by GPC | 170035 | 265876 | 477897 |
| Mₙ by GPC | 68574 | 64274 | 132595 |
| Kofler Tₘ (° C.) | 113 | 115 | 116 |
| 200% Tensile Set (%) | 14 | 10 | 11 |

¹1,6-Hexandiol-1,4-Butanediol Adipate

TABLE 4

| | Example | | |
|---|---|---|---|
| | 4 | 5 | 6 |
| Polyester Polyol (g)¹ | 181.79 | 181.79 | 181.79 |
| 1,12-Dodecanediol (1,12-Diol) (g) | 18.21 | 18.21 | 18.21 |
| MDI (g) | 39.97 | 40.27 | 40.58 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2500 | 2500 | 2500 |
| 1,12-Diol M_{w} | 202 | 202 | 202 |
| MDI M_{w} | 250.4 | 250.4 | 250.4 |
| CE/Polyol Mole Ratio | 1.240 | 1.240 | 1.240 |
| Stoichiometry (%) | 98.00 | 98.75 | 99.50 |
| Tₘ by DSC (° C.) | 117 | 116 | 115 |
| T_{g} by DSC (° C.) | −43 | −45 | −41 |
| T_{c} by DSC (° C.) | 12 | 9 | 10 |
| M_{w} by GPC | 223462 | 363169 | 435600 |
| Mₙ by GPC | 76047 | 115612 | 94168 |
| Kofler Tₘ (° C.) | 109 | 110 | 110 |
| 200% Tensile Set (%) | 11 | 11 | 8 |

¹1,6-Hexandiol-1,4-Butanediol Adipate

TABLE 5

| | Example | | |
|---|---|---|---|
| | 7 | 8 | 9 |
| Polyester Polyol 1 (g)³ | 84.00 | 84.00 | 84.00 |
| Polyester Polyol 2 (g)⁴ | 84.00 | 84.00 | 84.00 |
| 1,12-Dodecanediol (1,12-Diol) (g) | 32.00 | 32.00 | 32.00 |
| MDI (g) | 67.69 | 69.12 | 70.54 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol 1 Mₙ | 2156.4 | 2156.4 | 2156.4 |
| Polyester Polyol 2 Mₙ | 963.4 | 963.4 | 963.4 |
| 1,12-Diol M_{w} | 202 | 202 | 3202 |
| MDI M_{w} | 250.4 | 250.4 | 250.4 |
| CE/Polyol Mole Ratio | 1.256 | 1.256 | 1.256 |
| Stoichiometry (%) | 95.00 | 97.00 | 99.00 |
| Tₘ by DSC (° C.) | 125 | 125 | 125 |
| T_{g} by DSC (° C.) | −27 | −13 | −12 |
| T_{c} by DSC (° C.) | 34 | 31 | None |
| M_{w} by GPC | 53839 | 80650 | 163961 |
| Mₙ by GPC | 25960 | 38361 | 62741 |
| Kofler Tₘ (° C.) | 97 | 99 | 103 |
| 200% Tensile Set (%) | 33 | 27 | 21 |

³1,6 Hexanediol-Neopental diol Adipate from Inolex as Lexorez ® 1400-56
⁴1,6 Hexanediol-Neopental diol Adipate from Inolex as Lexorez ® X1400-120

TABLE 6

| | Example | | |
|---|---|---|---|
| | 10 | 11 | 12 |
| Polyeater Polyol (g)³ | 178.00 | 178.00 | 178.00 |
| 1,12-Dodecanediol (1,12-Diol) (g) | 22.00 | 22.00 | 22.00 |
| MDI (g) | 47.08 | 47.07 | 49.06 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2000 | 2000 | 2000 |
| 1,12-Diol M_{w} | 202 | 202 | 202 |
| MDI M_{w} | 250.4 | 250.4 | 250.4 |
| CE/Polyol Mole Ratio | 1.224 | 1.224 | 1.224 |
| Stoichiometry (%) | 95.00 | 97.00 | 99.00 |
| Tₘ by DSC (° C.) | 121 | 121 | 120 |
| T_{g} by DSC (° C.) | −30 | −29 | −28 |
| T_{c} by DSC (° C.) | 20 | None | None |
| M_{w} by GPC | 99648 | 134606 | 185899 |
| Mₙ by GPC | 41959 | 50625 | 61427 |
| Kofler Tₘ (° C.) | 92 | 92 | 95 |
| 200% Tensile Set (%) | 15 | 13 | 11 |

³1,6 Hexanediol-Neopental diol Adipate from Inolex as Lexorez ® 1400-56

TABLE 7

| | Example | | |
|---|---|---|---|
| | 13 | 14 | 15 |
| Polyester Polyol (g)¹ | 181.79 | 181.79 | 181.79 |
| 1,12-Dodecanediol (1,12-Diol) (g) | 18.21 | 18.21 | 18.21 |
| MDI (g) | 38.74 | 39.15 | 39.56 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 2500 | 2500 | 2500 |
| 1,12-Diol M_{w} | 202 | 202 | 202 |
| MDI M_{w} | 250.4 | 250.4 | 250.4 |
| CE/Polyol Mole Ratio | 1.240 | 1.240 | 1.240 |
| Stoichiometry (%) | 95.00 | 96.00 | 97.00 |
| Tₘ by DSC (° C.) | 118 | 119 | 118 |
| T_{g} by DSC (° C.) | −45 | −42 | −43 |
| T_{c} by DSC (° C.) | 21 | 17 | 15 |
| M_{w} by GPC | 112522 | 145889 | 210393 |
| Mₙ by GPC | 51097 | 62785 | 80152 |
| Kofler Tₘ (° C.) | 95 | 98 | 102 |
| 200% Tensile Set (%) | 13 | 11 | 10 |

11,6-Hexandiol-1,4-Butanediol Adipate

TABLE 8

| | Example | | |
|---|---|---|---|
| | 16 | 17 | 18 |
| Polyester Polyol (g)⁵ | 168.00 | 168.00 | 168.00 |
| 1,12-Dodecanediol (1,12-Diol) (g) | 32.00 | 32.00 | 32.00 |
| MDI (g) | 70.23 | 70.77 | 71.31 |
| Blend Temperature (° C.) | 120 | 120 | 120 |
| MDI Temperature (° C.) | 120 | 120 | 120 |
| Reaction Time (Minutes) | 3 | 3 | 3 |
| Polyester Polyol Mₙ | 1300 | 1300 | 1300 |
| 1,12-Diol M_{w} | 202 | 202 | 202 |
| MDI M_{w} | 250.4 | 250.4 | 250.4 |
| CE/Polyol Mole Ratio | 1.226 | 1.226 | 1.226 |
| Stoichiometry (%) | 97.50 | 98.25 | 99.00 |
| Tₘ by DSC (° C.) | 126 | 131 | 127 |
| T_{g} by DSC (° C.) | −33 | −29 | −26 |
| T_{c} by DSC (° C.) | 41 | 38 | 36 |
| M_{w} by GPC | 136017 | 179452 | 135693 |
| Mₙ by GPC | 55102 | 64235 | 53741 |
| Kofler Tₘ (° C.) | 101 | 102 | 102 |
| 200% Tensile Set (%) | 25 | 24 | 21 |

⁵1,4-Butanediol Adipate

As discussed above, the thermoplastic polyurethane elastomer compositions of the present invention can be used to form any suitable article. Exemplary articles include pellets and films.

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

What is claimed is:

1. A thermoplastic polyurethane elastomer composition comprising:
the reaction product of:
(a) at least one polyester polyol selected from one or more polyadipates, one or more polyazelates, one or more polybutyrates, one or more polycarbonates, or a suitable combinations of two or more thereof;
(b) at least one polyisocyanate; and
(c) at least one diol chain extender, where the at least one chain extender comprises one or more compounds according to the following formula:
OH—(CH₂)ₓ—OH
where x is either equal to 5 or is an integer in the range of 7 to about 30, and wherein the at least one polyisocyanate comprises at least about 95 weight percent of diphenylmethane-4,4′-diisocyanate.

2. The thermoplastic polyurethane elastomer of claim 1, wherein the overall number average molecular weight of the at least one polyester polyol is in the range of from about 1,000 to about 15,000.

3. The thermoplastic polyurethane elastomer of claim 1, wherein the overall number average molecular weight of the at least one polyester polyol is in the range of from about 2,000 to about 10,000.

4. The thermoplastic polyurethane elastomer of claim 1, wherein x is an integer in the range of about 8 to about 25.

5. The thermoplastic polyurethane elastomer of claim 4, wherein x is in the range of about 9 to about 20.

6. The thermoplastic polyurethane elastomer of claim 4, wherein x is in the range of about 9 to about 12.

7. The thermoplastic polyurethane elastomer of claim 1, wherein x is equal to 5.

8. The thermoplastic polyurethane elastomer of claim 1, wherein the at least one polyisocyanate comprises at least about 97 weight percent of diphenylmethane-4,4′-diisocyanate.

9. A thermoplastic polyurethane film formed from the compound of claim 1.

10. A thermoplastic polyurethane elastomer composition comprising:
the reaction product of:
(a) at least one polyester polyol selected from one or more polyadipates, one or more polyazelates, one or more polybutyrates, one or more polycarbonates, or a suitable combinations of two or more thereof;
(b) at least one polyisocyanate; and
(c) at least one diol chain extender, where the at least one chain extender comprises one or more compounds according to the following formula:
OH—(CH₂)ₓ—OH
where x is an integer in the range of 8 to about 25, wherein the at least one polyisocyanate comprises at least about 95 weight percent of diphenylmethane-4,4′-diisocyanate, and wherein the overall number average molecular weight of the at least one polyester polyol is in the range of from about 2,000 to about 15,000.

11. The thermoplastic polyurethane elastomer of claim 10, wherein the overall number average molecular weight of the at least one polyester polyol is in the range of from about 2,500 to about 10,000.

12. The thermoplastic polyurethane elastomer of claim 10, wherein x is an integer in the range of about 9 to about 20.

13. The thermoplastic polyurethane elastomer of claim 12, wherein x is in the range of about 9 to about 12.

14. The thermoplastic polyurethane elastomer of claim 10, wherein the at least one polyisocyanate comprises at least about 97 weight percent, of diphenylmethane-4,4′-diisocyanate.

15. A thermoplastic polyurethane film formed from the compound of claim 10.

16. An extruded thermoplastic polyurethane elastomeric film formed from a thermoplastic polyurethane elastomer composition comprising:
the reaction product of:
(a) at least one polyester polyol;
(b) at least one polyisocyanate; and
(c) at least one diol chain extender, where the at least one chain extender comprises one or more compounds according to the following formula:
OH—(CH₂)ₓ—OH
where x is either equal to 5 or is an integer in the range of 7 to about 30, and wherein the at least one polyisocyanate comprises at least about 95 weight percent of diphenylmethane-4,4′-diisocyanate.

17. The extruded thermoplastic polyurethane elastomer film of claim 16, wherein the overall number average molecular weight of the at least one polyester polyol is in the range of from about 1,000 to about 15,000.

18. The extruded thermoplastic polyurethane elastomer flirt of claim 16, wherein the overall number average molecular weight of the at least one polyester polyol is in the range of from about 2,000 to about 10,000.

19. The extruded thermoplastic polyurethane elastomer film of claim 16, wherein the at least one polyester polyol is selected from one or more polyadipates, one or more polyazelates, one or incite polybutyrates, one or more polycarbonates, or a suitable combinations of two or more thereof.

20. The extruded thermoplastic polyurethane elastomer film of claim 16, wherein x is an integer in the range of about 8 to about 25.

21. The extruded thermoplastic polyurethane elastomer film of claim 20, wherein x is in the range of about 5 to about 20.

22. The extruded thermoplastic polyurethane elastomer film of claim 20, wherein x is in the range of about 9 to about 12.

23. The extruded thermoplastic polyurethane elastomer film of claim 16, wherein x is equal to 5.

24. The extruded thermoplastic polyurethane elastomer film of claim 16, wherein the at least one polyisocyanate comprises at least about 97 weight percent of diphenylmethane-4,4′- diisocyanate.

25. The extruded thermoplastic polyurethane elastomer film of claim 24, wherein the at least one polyisocyanate comprises at least about 98 weight percent of diphenylmethane-4,4′-diisocyanate.

26. The extruded thermoplastic polyurethane elastomer film of claim 24, wherein the at least one polyisocyanate comprises at least about 99 weight percent of diphenylmethane-4,4′-diisocyanate.

27. An extruded thermoplastic polyurethane elastomeric film formed from a thermoplastic polyurethane elastomer composition comprising:
the reaction product of:
(a) at least one polyester polyol;
(b) at least one polyisocyanate; and
(c) at least one diol chain extender, where the at least one chain extender comprises one or more compounds according to the following formula:
OH—(CH₂)ₓ—OH
where x is an integer in the range of 8 to about 25, wherein the at least one polyisocyanate comprises at least about 95 weight percent of diphenylmethane-4,4′-diisocyanate, and wherein the overall number average molecular weight of the at least one polyester polyol is in the range of from about 2,000 to about 15,000.

28. The extruded thermoplastic polyurethane elastomer film of claim 27, wherein the overall number average molecular weight of the at least one polyester polyol is in the range of from about 2,500 to about 10,000.

29. The extruded thermoplastic polyurethane elastomer film of claim 27, wherein the at least one polyester polyol is selected from one or more polyadipates, one or more polyazelates, one or more polybutyrates, one or more polycarbonates, or a suitable combinations of two or more thereof.

30. The extruded thermoplastic polyurethane elastomer film of claim 27, wherein x is in the range of about 9 to about 20.

31. The extruded thermoplastic polyurethane elastomer film of claim 30, wherein x is in the range of about 9 to about 12.

32. The extruded thermoplastic polyurethane elastomer film of claim 27, wherein the at least one polyisocyanate comprises at least about 97 weight percent of diphenylmethane-4,4′-diisocyanate.
